(19) United States
(12) Patent Application Publication
(10) Pub. No.: US 2002/0048253 A1
(43) Pub. Date: Apr. 25, 2002

(54) Position device capable of adjusting inclining angle thereof

(75) Inventor: Chii-How Chang, Taoyuan Hsien (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Delta Electronics, Taoyuan Hsien (TW)

(21) Appl. No.: 09/864,966

(22) Filed: May 24, 2001

(30) Foreign Application Priority Data
Oct. 24, 2000 (TW) 89218481

(51) Int. Cl. G11B 21/16; H02K 41/00; G11B 7/00; G11B 17/00

(52) U.S. Cl. 369/244; 310/12; 369/44.14

(57) ABSTRACT

A position device is capable of adjusting an inclining angle thereof for using in a driver. The position device includes a movable element, a fixed element for generating a movable magnetic field to move the movable element, and an inclining angle coil assembly for generating a inclining magnetic field to incline the movable element, thereby adjusting the inclining angle of the position device.

### FIELD OF THE INVENTION

The present invention relates to a position device, and more particularly to a position device capable of adjusting an inclining angle thereof for using in a driver.

### BACKGROUND OF THE INVENTION

Generally, data storage media for accessing and recording the data are supported by drivers. The magnetic storage devices, for example, FDD (floppy disk drive) or HDD (hard disk drive), have drivers for magnetic read/write heads. The optical storage devices, for example, Compact Disc (CD), Video CD (VCD) and Digital Video Disk (DVD), have corresponding drivers for optical read/write heads. In addition, Magneto Optical (MO) or Mini Disc (MD) has corresponding drivers for read/write heads. The drivers are used for precisely directing the read/write heads to the working positions.

The position device of the conventional drivers is implemented by using the characteristic of magnetism. FIGS. 1 to 3 are schematic views showing the conventional magnetic position devices for being used in the optical lens (O.L.) driver for an optical read/write head.

The operation principles applied in the drivers are similar. The magnetic field is generated by the permanent magnets M1 and M2 and the fixed yokes Y1, Y2 and Y3. When electric current passes through the focusing coil F1 or the tracking coils T1, T2, T3 and T4, another variable magnetic field is generated owing to electromagnetic induction, and then the relative displacement between the coils and the magnets are generated. The variable relative displacement is regulated by the electric current.

However, an inclining angle is generated by the assembled error or design error according to the prior art. Further, the largest inclining angle is generated when the movable member V is moved to the most deflective location of the drivers. Moreover, a systematic aberration occurs when the inclining angle is generated due to the relative place between the optical lens O.L and the location for data storage. Therefore, the correct data could not be obtained and the reliability for the drivers is decreased.

It is therefore tried by the applicant to deal with the above situation encountered in the prior art.

### SUMMARY OF THE INVENTION

It is therefore an object of the present invention to provide a position device capable of adjusting an inclining angle thereof for using in a driver, in which the position device includes an inclining angle coil assembly to generate an incline magnetic field for adjusting the inclining angle.

It is another object of the present invention to provide the position device capable of adjusting an inclining angle thereof for using in a driver so as to have a precise position control to enhance the reliability for the position device.

According to an aspect of the present invention, the position device includes a movable element, a fixed element for generating a movable magnetic field to move the movable element, and an inclining angle coil assembly for generating an inclining magnetic field to incline the movable element, thereby adjusting the inclining angle of the position device.

Preferably, the fixed element further includes a magnet module and a yoke assembly connected to the magnet module for generating the movable magnetic field.

The magnet module preferably includes a plurality of permanent magnets.

Preferably, the inclining angle coil assembly is wound around the yoke assembly.

The movable element preferably includes a focusing coil assembly.

Preferably, the focusing coil assembly generates a focusing magnetic field.

Preferably, the movable element generates a rotating torque by the interaction of the focusing magnetic field and the inclining magnetic field.

Preferably, the inclining angle coil assembly includes four inclining angle coils wound around four different portions of the yoke assembly, respectively.

Preferably, the inclining angle coil assembly is wound around the movable element.

Preferably, the inclining angle coil assembly is wound into a shape of “8” and includes an inclining angle coil.

Preferably, the inclining angle coil assembly further includes two inclining angle coils, and they are mounted on two opposite sides of the movable element, respectively.

Preferably, the driver is a read/write head of an optical reading device.

The movable element preferably includes an optical lens.

The present invention may best be understood through the following descriptions with reference to the accompanying drawings, in which:

### BRIEF DESCRIPTION OF THE DRAWINGS

FIGS. 1 to 3 are schematic views showing the position devices for using in a driver according to the prior art;

FIGS. 4a and 4b are schematic views showing a position device capable of adjusting an inclining angle thereof for using in a driver according to the first preferred embodiment of the present invention;

FIGS. 5a and 5b are schematic views showing a position device capable of adjusting an inclining angle thereof for using in a driver according to the second preferred embodiment of the present invention;

FIGS. 6a and 6b are schematic views showing a position device capable of adjusting an inclining angle thereof for using in a driver according to the third preferred embodiment of the present invention;

FIG. 7 is a schematic view showing a position device capable of adjusting an inclining angle thereof for using in a driver according to the fourth preferred embodiment of the present invention;

FIGS. 8a and 8b are schematic views showing a position device capable of adjusting an inclining angle thereof for using in a driver according to the fifth preferred embodiment of the present invention;

FIGS. 9a and 9b are schematic views showing a magnetic position device having halves of FIGS. 8a and 8b, respectively; and

FIGS. 10 to 13 are schematic views showing a position device according to the modified preferred embodiments of the present invention.

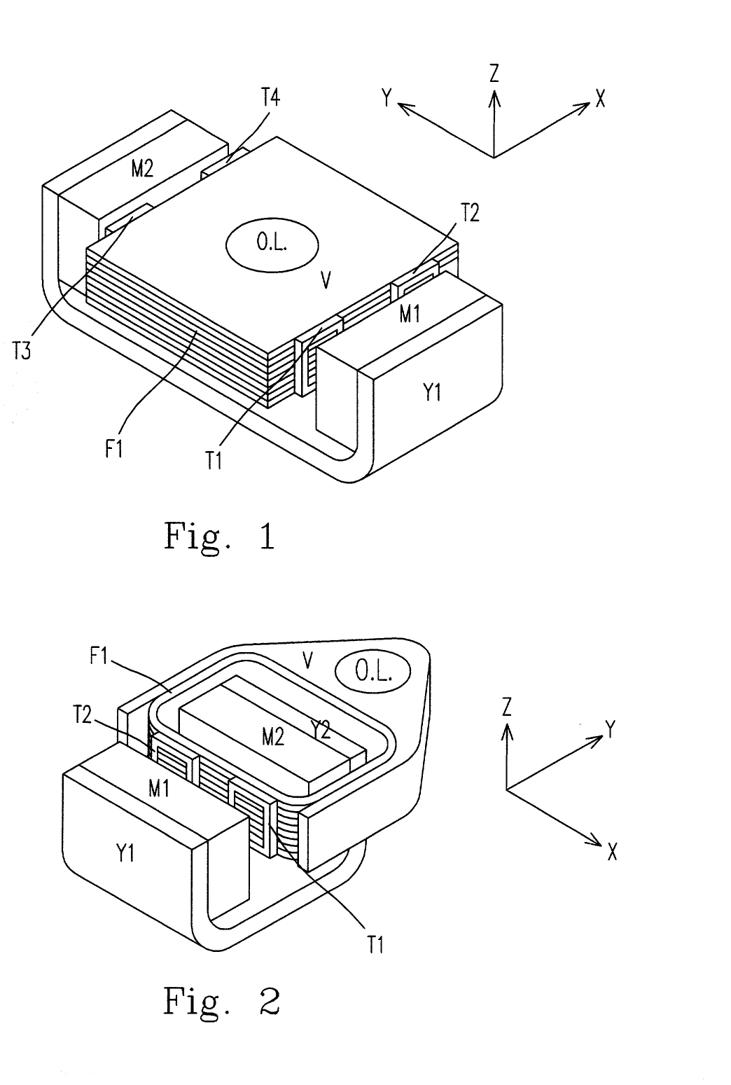

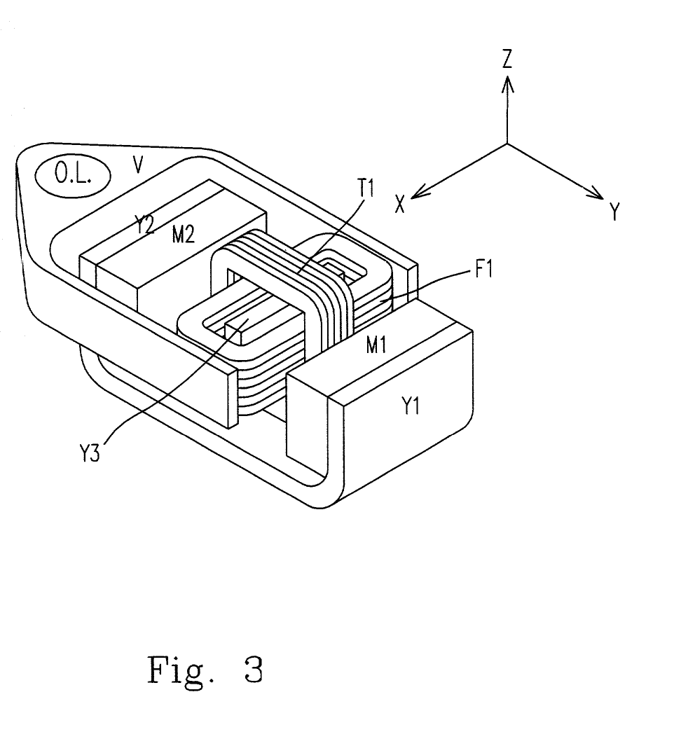

### DETAILED DESCRIPTION OF THE PREFERRED EMBODIMENTS

A position device capable of adjusting an inclining angle thereof for using in a driver is provided. The present invention is implemented by using an inclining angle coil assembly to regular a position angle of a movable element for the driver.

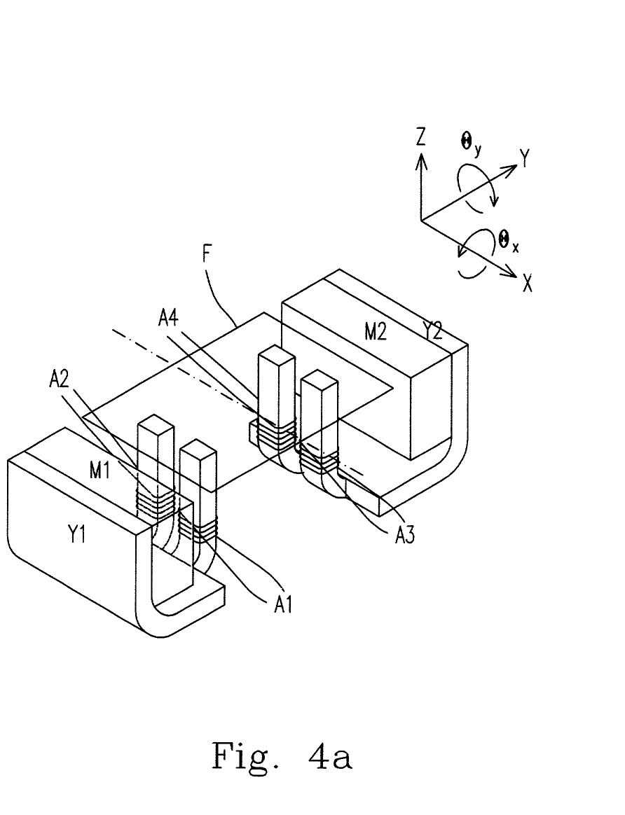

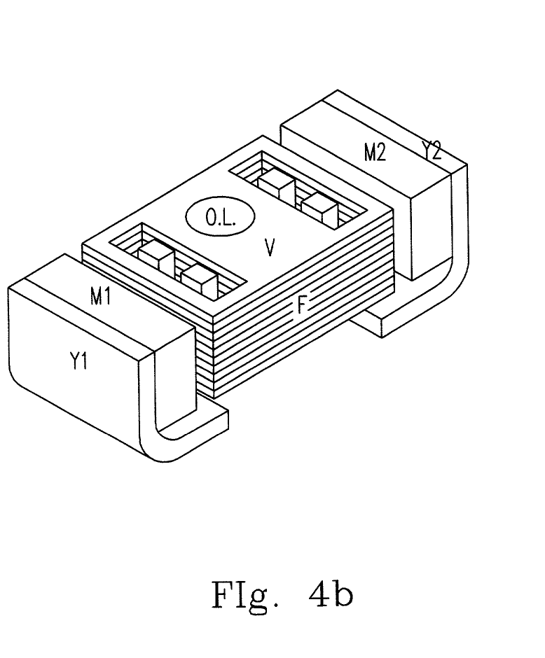

FIGS. 4a and 4b show a position device capable of adjusting an inclining angle thereof according to the first preferred embodiment of the present invention. Four inclining angle coils A1 to A4 are wound around four sub-yokes which are connected to main yokes Y1 and Y2, respectively, as shown in FIG. 4a. When electric current passes through the inclining angle coils A1 to A4, an inclining magnetic field is generated. The inclining magnetic field regulated by electric current could enhance or offset a focusing magnetic field generated by a focusing coil F on four corners of the driver. Thus, a movable element V is slanted towards the inclining magnetic field. Referring to FIG. 4b, a focusing coil is wound around the movable element V and the movable element V further includes an optical lens O.L. While the focusing coil F is controlled, the inclining angle of the optical lens O.L. is regulated to enhance the position precision of the driver.

Please refer to FIG. 4(a). When the inclining angle coils A1 and A3 are induced to resist the current of the magnetic field generated by permanent magnets M1 and M2 and the inclining angle coils A2 and A4 are not electrically conducted, the magnetic field generated by the focusing coil F on X+ semi-plane of a Cartesian coordinate system is reduced and the magnetic field generated by the focusing coil F on X− semi-plane of the Cartesian coordinate system is constant. At present, a summation magnetic force would generate a torque toward +Θ_{y} direction when the electric current passes through the focusing coil F and it will make Z+ direction movement. A summation magnetic force would generate a torque toward −Θ_{y} direction when the electric current passes through the focusing coil F and it will make Z− direction movement.

In addition, when the inclining angle coils A1 and A2 are induced to resist the current of the magnetic field generated by permanent magnets M1 and M2 and the inclining angle coils A3 and A4 are not electrically conducted, the magnetic field generated by the focusing coil F on Y− semi-plane of a Cartesian coordinate system is reduced and the magnetic field generated by the focusing coil F on Y+ semi-plane of the Cartesian coordinate system is constant. At present, a summation magnetic force would generate a torque toward +Θₓ direction when the electric current passes through the focusing coil F and it will make Z+ direction movement. A summation magnetic force would generate a torque toward −Θₓ direction when the electric current passes through the focusing coil F and it will make Z− direction movement. Therefore, the inclining angle for the optical lens O.L. can be regulated in the directions of Θₓ axis and Θ_{y} axis according to the above-mentioned torque formation.

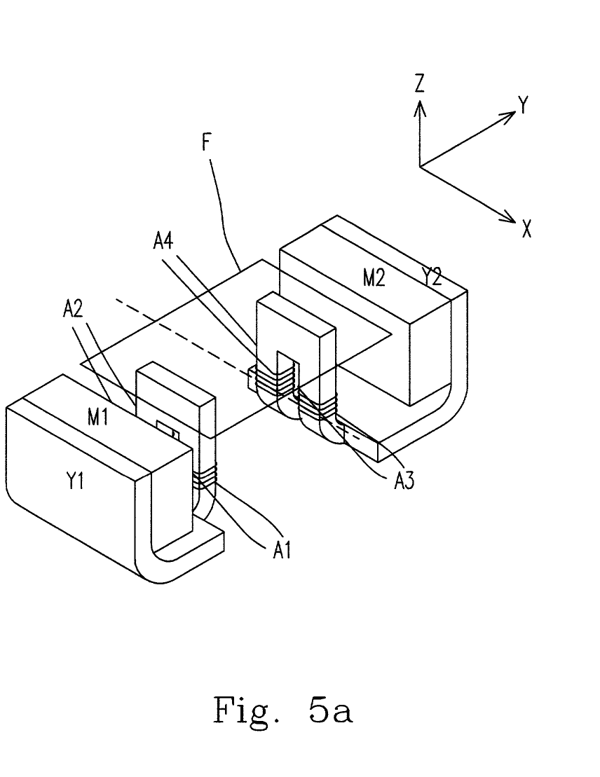

FIGS. 5a and 5b show the position device according to the second preferred embodiments of the present invention. Referring to FIGS. 5a and 5b, the position device is modified by varying the yokes Y1 and Y2 in FIGS. 4a and 4b. The operation principle is similar to FIGS. 4a and 4b. The movable element V added on the position device can be shown in FIG. 5b.

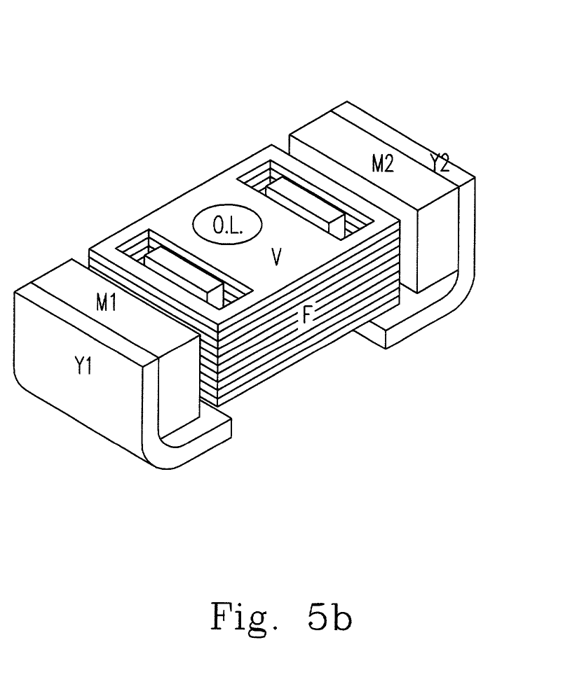

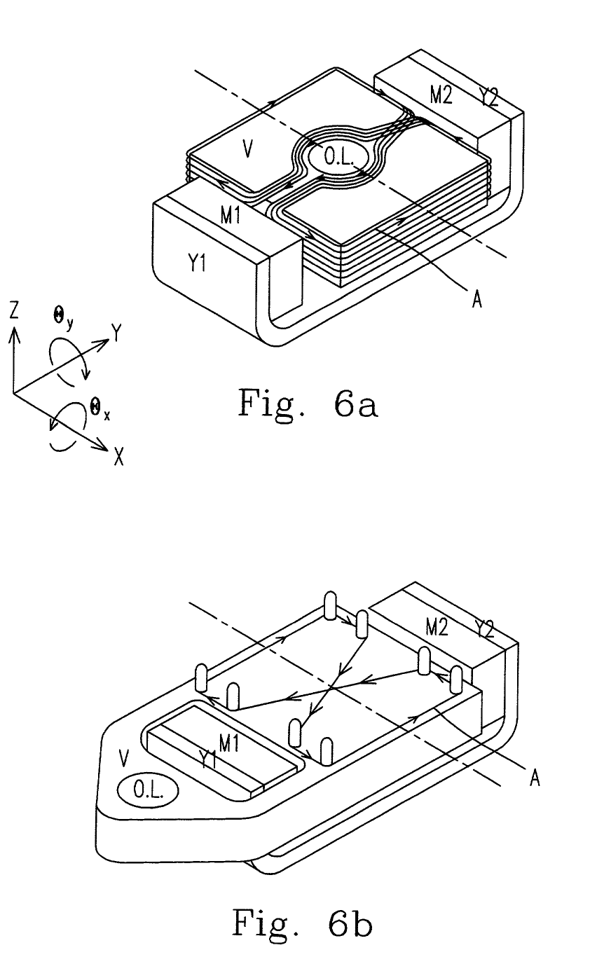

FIGS. 6a and 6b show the position device according to the third preferred embodiments of the present invention. An inclining angle coil A is wound around the movable element V and is wound into a shape of “8”. When electric current in the direction shown in FIGS. 6a and 6b passes through the inclining angle coil A, a torque toward −Θ_{y} direction is generated. Moreover, a torque in the opposite direction is generated when electric current passes through the inclining angle coil A in opposite direction. The operation principle is similar to the abovementioned description and the manufacturing process is timesaving for winding coils. FIG. 6b shows the position device by varying the movable element V and the optical lens O.L. in FIG. 6a.

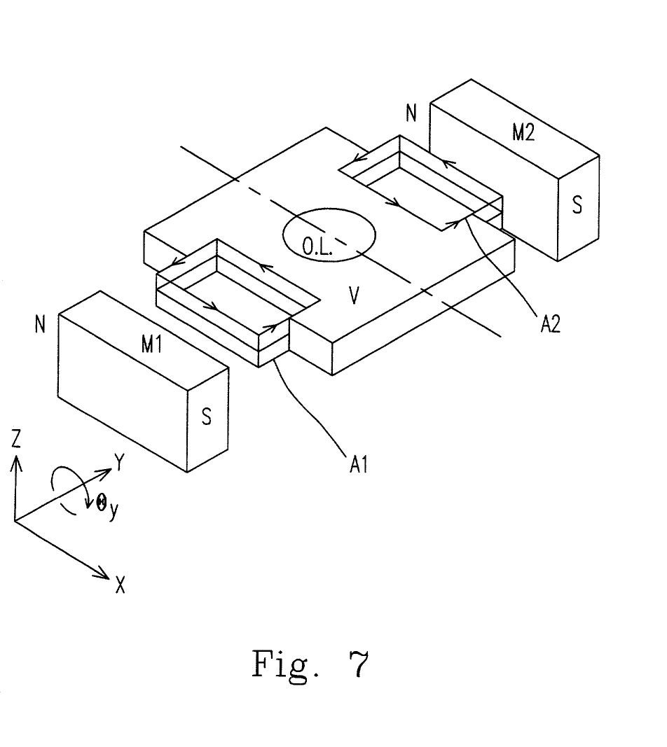

FIG. 7 shows the position device according to the forth preferred embodiments of the present invention. Two inclining coils A1 and A2 are added on the two ends of the movable element V. A torque toward +Θ_{y} direction is generated when the electric current passes in the direction shown in FIG. 7, and −Θ_{y} direction torque is generated in the opposite electric current direction for adjusting an inclining angle of the movable element V. A simple construction and shorter and lighter coils are developed in the preferred embodiments of the present invention.

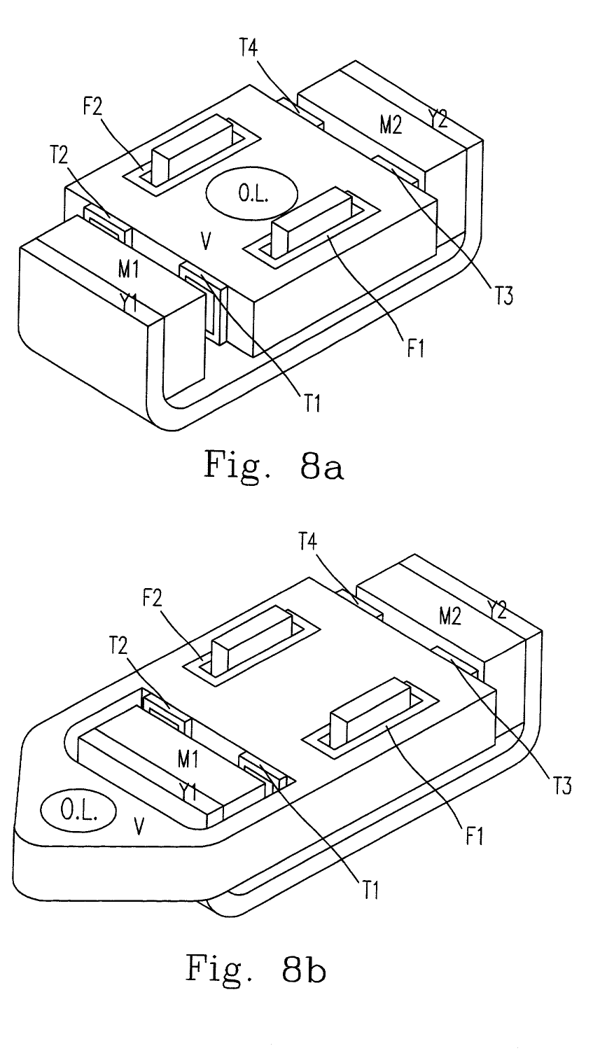

FIGS. 8a and 8b show the position device according to the fifth preferred embodiments of the present invention. A focusing magnetic field is generated by the focusing coils F1 and F2. The focusing coils F1 and F2 are regarded as the inclining coils in this embodiment. The inclining angle for the movable element V is regulated by different electric current passing through the focusing coils F1 and F2, i.e. the inclining coils. FIG. 8b shows the position device by varying the movable element V and the optical lens O.L. in FIG. 8a.

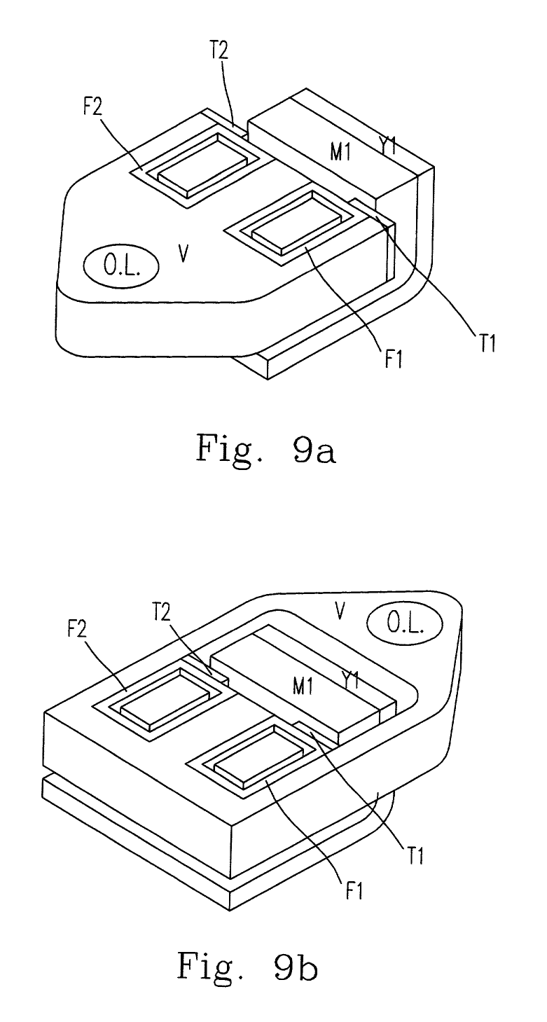

FIGS. 9a and 9b show a position device having halves of FIGS. 8a and 8b, respectively. FIG. 9b shows a position device by varying the movable element V and the optical lens O.L. in FIG. 9a.

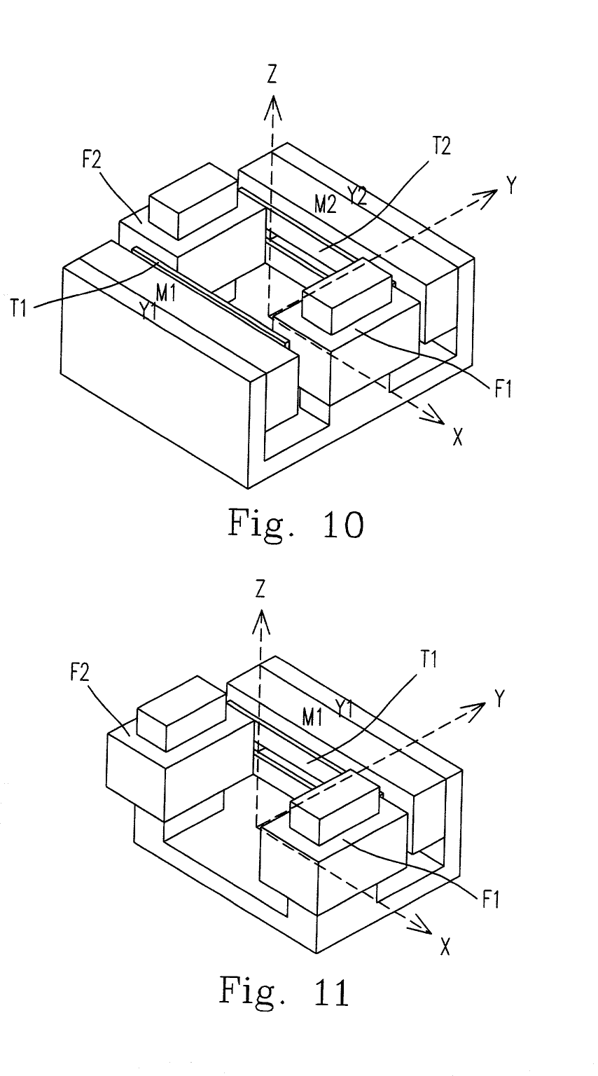

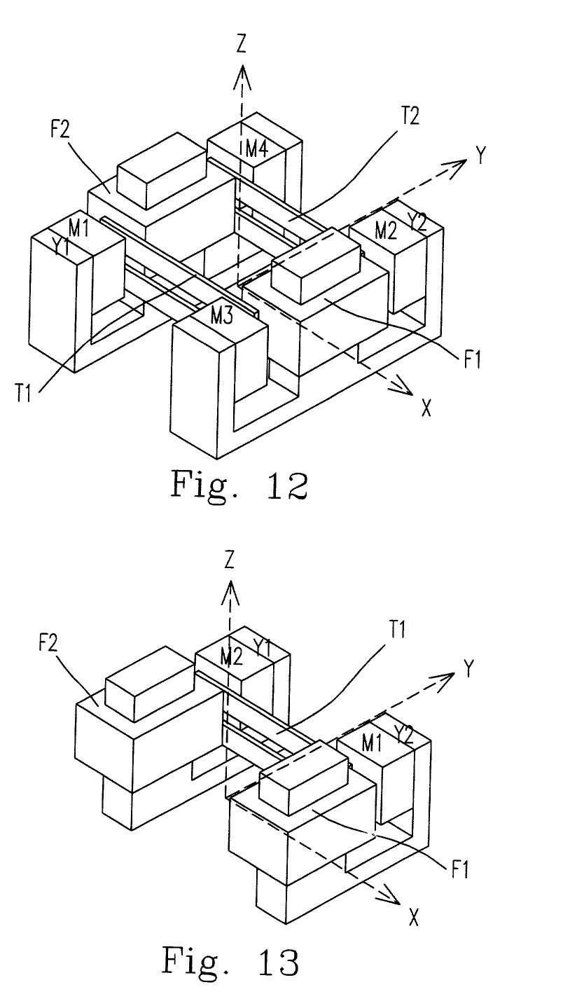

The modified preferred embodiments of the present invention are further developed according to FIGS. 8a and 8b. FIG. 10 shows a position device combined with the tracking coils T1 and T2 in FIGS. 8a and 8b. FIG. 11 shows a position device having a half of FIG. 10. FIG. 12 shows a position device by dividing the yokes Y1 and Y2 and the permanent magnets M1 and M2 in FIG. 10 into two parts. FIG. 11 shows a position device having a half of FIG. 12.

The position device in the above-mentioned modified embodiments have similar effects and are designed to be applied to different operation conditions for decreasing the weight of the permanent magnets or coils. In addition, the modified embodiments further employ the original focusing coils to regulate without assembling the extra coils structures for adjusting inclining angle of the movable element V.

It is understood that the position device capable of adjusting an inclining angle thereof for using in a driver could be flexibly applied to different operation conditions. Moreover, the reliability for the position device capable of adjusting an inclining angle thereof could be enhanced without assembling the extra structures according to the present invention.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What we claim is:

1. A position device capable of adjusting an inclining angle thereof for using in a driver, comprising:
a movable element;
a fixed element for generating a movable magnetic field to move said movable element; and
an inclining angle coil assembly for generating an inclining magnetic field to incline said movable element, thereby adjusting said inclining angle of said position device.

2. The position device according to claim 1, wherein said fixed element comprises:
a magnet module; and
a yoke assembly connected to said magnet module for generating said movable magnetic field.

3. The position device according to claim 2, wherein said magnet module comprises a plurality of permanent magnets.

4. The position device according to claim 2, wherein said inclining angle coil assembly is wound around said yoke assembly.

5. The position device according to claim 4, wherein said movable element comprises a focusing coil assembly.

6. The position device according to claim 5, wherein said focusing coil assembly generates a focusing magnetic field.

7. The position device according to claim 6, wherein said movable element generates a rotating torque by the interaction of said focusing magnetic field and said inclining magnetic field.

8. The position device according to claim 7, wherein said inclining angle coil assembly comprises four inclining angle coils wound around four different portions of said yoke assembly, respectively.

9. The position device according to claim 1, wherein said inclining angle coil assembly is wound around said movable element.

10. The position device according to claim 9, wherein said inclining angle coil assembly is wound into shape of “8”.

11. The position device according to claim 10, wherein said inclining angle coil assembly comprises an inclining angle coil.

12. The position device according to claim 9, wherein said inclining angle coil assembly comprises two inclining angle coils.

13. The position device according to claim 12, wherein said two inclining angle coils are mounted on two opposite sides of said movable element, respectively.

14. The position device according to claim 1, wherein said driver is a read/write head of an optical reading device.

15. The position device according to claim 14, wherein said movable element comprises an optical lens.
